(19) United States
(12) Patent Application Publication
(10) Pub. No.: US 2024/0230703 A9
(43) Pub. Date: Jul. 11, 2024

(54) Self-Expanding Windsock Assembly Having A Support Structure

(71) Applicant: Gutemberg Goncalves Groberio, Tampa, FL (US)

(72) Inventor: Gutemberg Goncalves Groberio, Tampa, FL (US)

(21) Appl. No.: 18/047,816

(22) Filed: Oct. 19, 2022

(51) Int. Cl. G01P 13/02

(52) U.S. Cl. CPC G01P 13/02

(57) ABSTRACT

The novel windsock assembly has a tapered sock. The tapered sock has surface indicia located on an outer wall surface of the tapered sock. It is within the scope of this invention for surface indicia to include, but not be limited to, a company's name, a person's name, a phone number, a team logo, text, a phrase, a photo, an image, numerical text, alphabetical text, alphanumerical text, and/or a logo. The first end of the tapered sock has a pocket. A hoop is retained within the pocket of the first end of the tapered sock. A rod has a first end located opposite a second end. The first end of the rod is connected to the hoop. The second end of the rod is connected to an attachment structure. The attachment structure is configured to connect to a vehicle.

### BACKGROUND OF THE INVENTION

### 1. Field of the Invention

This invention relates, generally, to a windsock configured to be connected to a vehicle and, more particularly, to an improved self-expanding windsock assembly having a support structure.

### 2. Background Art

Windsocks in today's market are configured to measure wind direction and intensity. Windsocks have a sock in the form of a tubular piece of tapered fabric. The sock is connected to a pole. A sock hoop is stitched into the broad end portion of the sock opening and is configured to keep the sock open so that wind may blow through the sock. A swivel is connected to the pole and is configured to rotate and/or pivot as the wind change occurs. When wind begins to blow toward the broad end portion of the tapered sock, a tunneling effect of the wind through this tapered sock causes the sides of the sock to expand away from each other. As a result of wind filling the sock, the windsock is lifted and oriented in a horizontal orientation in relation to the ground. In this horizontal orientation, surface indicia such as an image, text, a logo, and/or a picture, that is located on the outer surface of the windsock may be easily viewed. A windsock having surface indicia, such as, a company's name and/or phone number and/or a team logo that is connected to a vehicle may be a highly desirable means of mobile advertising.

A problem with windsocks in today's market occurs during windless conditions when the tapered sock fabric hangs vertically from the pole. As a result of windless conditions, surface indicia located on the outer surface of a windsock cannot be viewed by potential business prospects. In a particular example, when a vehicle having a windsock connected to a surface of the vehicle experiences a windless condition, such as during nonmovement when the vehicle is parked or stopped at a red light, the windsock becomes deflated and/or the sides of the windsock do not expand. As a result of nonmovement of a stationary vehicle, a windsock connected to the stationary vehicle has a substantially vertical orientation associated with a collapsed windsock. When advertising surface indicia located on a surface of a windsock is obstructed by, for example, the hanging folds of excess windsock material of a collapsed windsock, the revenue lost by a missed advertising opportunity may be costly. In particular, a potential advertising opportunity may be diminished and/or missed from this substantially vertical windsock orientation of a nonexpanded windsock. Thus, there is a need for a self-expanding windsock that maintains a horizontal and/or expanded orientation and full visibility of the outer wall surface of the windsock during both windy and windless conditions.

However, in view of the prior art considered as a whole at the time the present invention was made; it was not obvious to those of ordinary skill in the pertinent art how the identified needs could be fulfilled.

### SUMMARY OF THE INVENTION

The long-standing but heretofore unfulfilled need for a self-expanding windsock assembly having a support structure configured to connect to a vehicle and which also includes improvements that overcome the limitations of prior windsocks, is now met by a new, useful, and non-obvious invention.

The novel windsock assembly has a tapered sock. The tapered sock has an outer wall surface. The tapered sock has surface indicia located on an outer wall surface of the tapered sock. It is within the scope of this invention for surface indicia to include, but not be limited to, a company's name, a person's name, a phone number, a team logo, text, a phrase, a photo, an image, numerical text, alphabetical text, alphanumerical text, and/or a logo. The tapered sock has a first end having a first opening located opposite a second end having a second opening. The first opening of the first end of the tapered sock has an outer perimeter edge greater in size than an outer perimeter edge of the second opening of the second end of the tapered sock. The first end of the tapered sock has a pocket. A hoop is retained within the pocket of the first end of the tapered sock. A rod has a first end located opposite a second end. The first end of the rod is connected to the hoop. The second end of the rod is connected to an attachment structure. The attachment structure is configured to connect to a vehicle. It is within the scope of this invention for the attachment structure to include, but not be limited to, a suction cup, a clamp, a fastener, and/or a bracket. It is within the scope of this invention for the attachment structure of the windsock to connect to any outer and/or inner surface of the vehicle and/or any window surface of the window opening.

In an alternate embodiment, the novel self-expanding windsock may be expandable and has a support structure forming a housing. The support structure may be tapered to have an end that is greater in size than an opposite end. The housing of the support structure retains the electronics and switch of the expandable components. The support structure has a first end located opposite a second end. The first end of the housing has a U-shaped hoop guide bordering a first opening of the housing. The U-shaped hoop guide has a track configured to retain the hoop. The second end of the housing has a lip bordering a second opening of the housing. The lip is L-shaped and is configured to retain an extension member within the support structure housing. The extension member is configured to slidable traverse the inner wall surface of the support structure to elongate the windsock in a windless and/or substantially windless environment, when the windsock would otherwise be deflated in a vertical orientation in relation to the ground. In an alternate embodiment, the housing has a sidewall. The sidewall of the support structure and/or an extension member of the housing of the support structure has at least one opening configured for airflow. The at least one opening may be slanted at an angle to maximize airflow through the support structure.

The self-expanding windsock assembly may have a first end of the rod being connected to a bearing housing. The hoop is connected to the bearing housing of the first end of the rod. The bearing housing is configured to swivel the hoop in a direction of the wind.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective side view of the novel self-expanding windsock assembly connected to a vehicle;

FIG. 2 is an exploded front view of the novel self-expanding windsock assembly;

FIG. 3 is a side cut-away view of the novel self-expanding windsock assembly having a support structure with an expandable extension member in a substantially retracted orientation when the motor of a linear actuator is not activated when the manual switch is positioned “off” in an opened orientation in windy conditions;

FIG. 4 is a side cut-away view of the novel self-expanding windsock assembly having a support structure with an expandable extension member in a substantially extended orientation when the motor of a linear actuator is activated when the manual switch is positioned “on” in a closed orientation in non-windy conditions;

FIG. 5 is a wiring diagram of the novel self-expanding windsock assembly having a power source, a relay, and a linear actuator;

FIG. 6 is a side cut-away view of an alternate embodiment of the novel self-expanding windsock assembly having a support structure with a fan in communication with a sail switch, whereby, the shaft of the fan blades rotate when the motor is activated when the sail switch is positioned “on” in a closed orientation in non-windy conditions; and,

FIG. 7 is a side cut-away view of an alternate embodiment of the novel self-expanding windsock assembly having a support structure with a fan in communication with a sail switch, whereby, the shaft of the fan blades do not rotate when the motor is not activated when the sail switch is positioned “off” in an opened orientation in windy conditions.

### DETAILED DESCRIPTION OF THE PREFERRED EMBODIMENT

In the following detailed description of the preferred embodiments, reference is made to the accompanying drawings, which form a part hereof, and within which are shown by way of illustrating specific embodiments by which the invention may be practiced. It is to be understood that other embodiments may be utilized and structural changes may be made without departing from the scope of the invention.

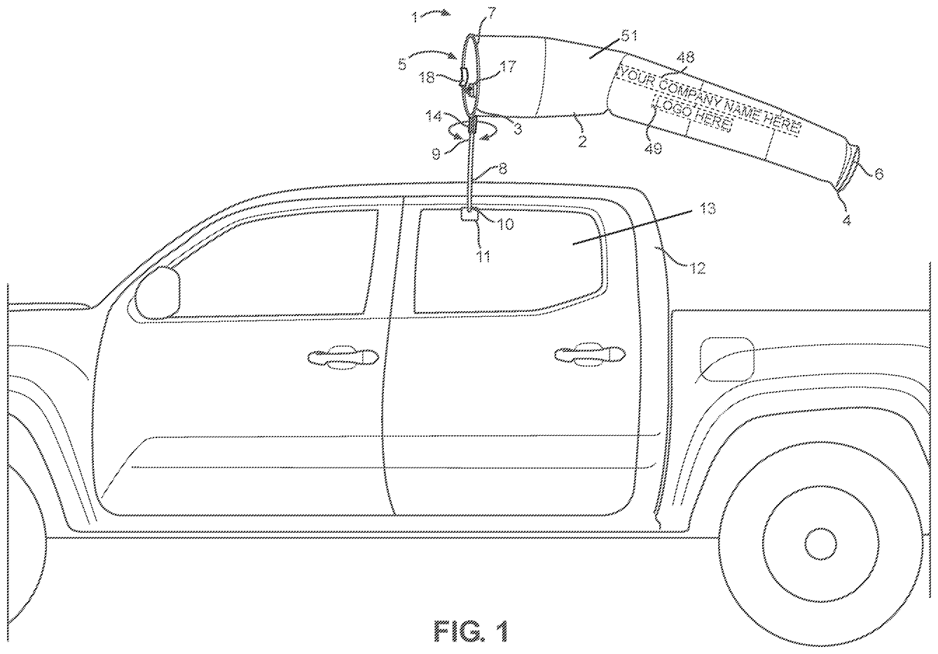

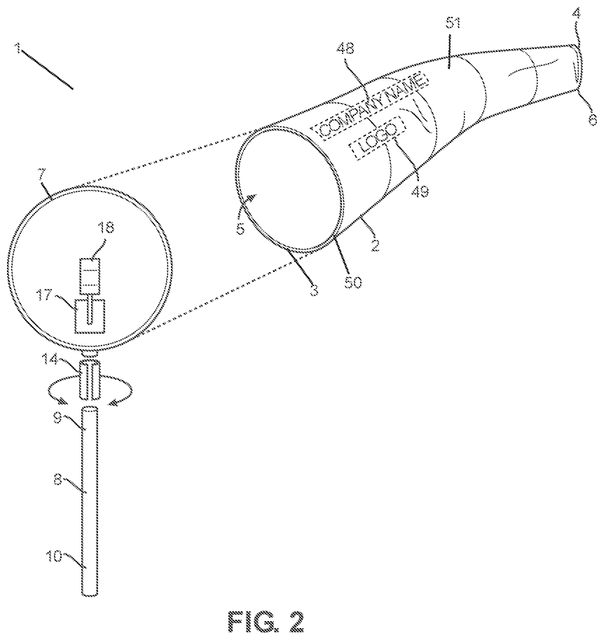

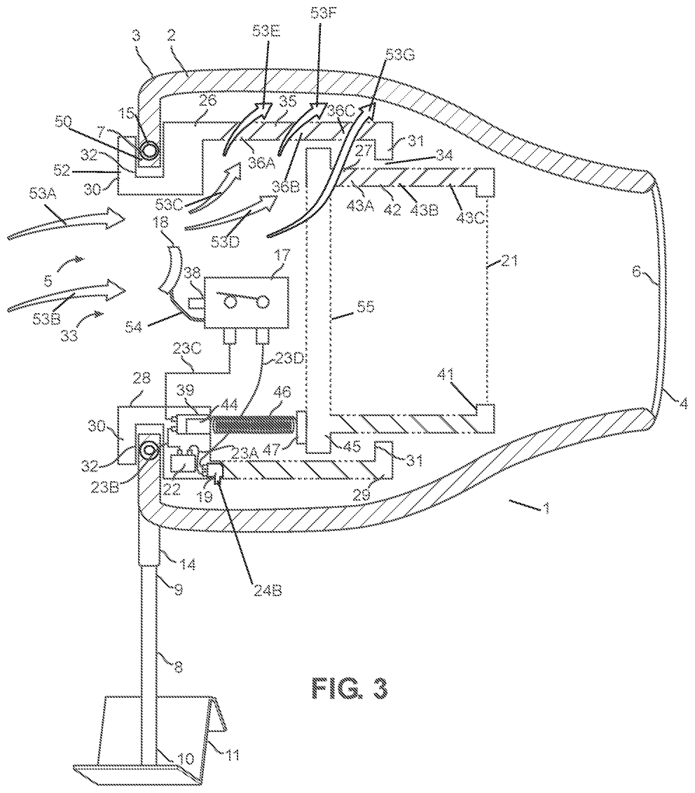

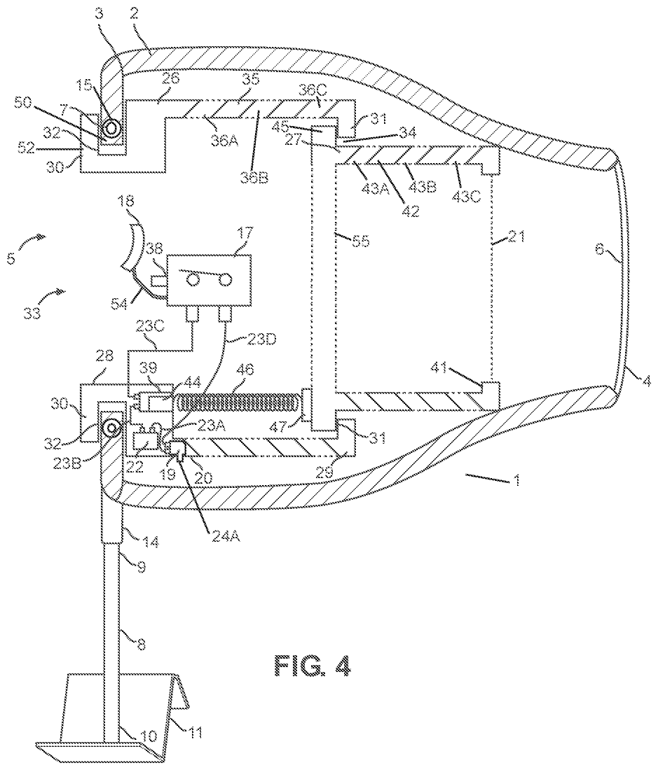

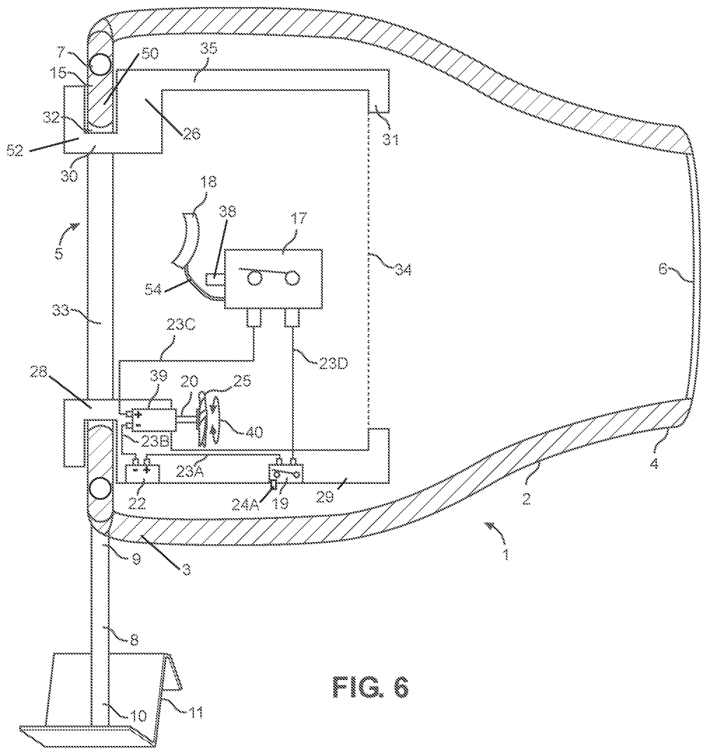

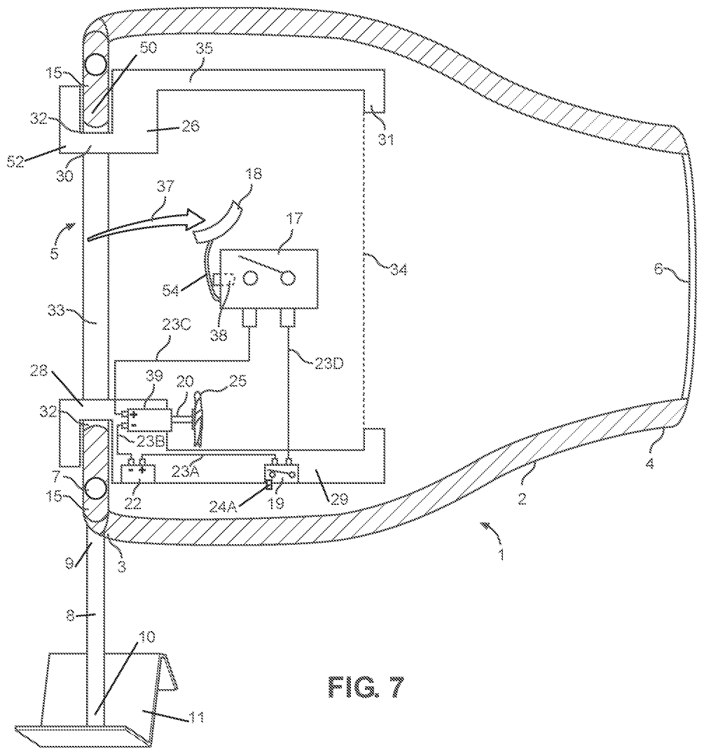

Referring to FIGS. 1 and 2, in a preferred embodiment tapered sock 2 has outer wall surface 51 with surface indicia 48 including, but not limited to, a logo 49. FIGS. 1-4 and 6-7 show self-expanding windsock assembly 1 having tapered sock 2 having first end 3 with first opening 5 located opposite second end 4 of tapered sock 2 having second opening 6. First opening 5 of first end 3 of tapered sock 2 has an outer perimeter edge greater in size than an outer perimeter edge of second opening 6 of second end 4 of tapered sock 2. It is within the scope of this invention for first end 3 of tapered sock 2 being any magnetic material 50 (FIG. 2) capable of magnetically connecting to magnetic hoop 7 or to magnetic portion 52 (FIGS. 3-4 and 6-7) of support structure 26 (FIGS. 3-4 and 6-7). Referring now to FIGS. 3-4 and 6-7, hoop 7 is retained within pocket 15 of first end 3 of tapered sock 2. Although pocket 15 of FIGS. 3-4 is smaller in size than pocket 15 of FIGS. 6-7, it is within the scope of this invention for pocket 15 to be any size capable of retaining hoop 7.

FIGS. 1-4 and 6-7 illustrate rod 8 having first end 9 located opposite second end 10. First end 9 of rod 8 is connected in communication with hoop 7. For example, FIGS. 6-7 show rod 8 connected directly to hoop 7 or may be connected to an adapter including, but not limited to, bearing housing 14 (FIGS. 1-4). It is within the scope of this invention for bearing housing to be capable of rotating and/or swiveling with an opening configured to receive at least a portion of rod 8. Second end 10 of rod 8 is connected to attachment structure 11. Attachment structure 11 is configured to connect to vehicle 12 (FIG. 1). Attachment structure 11 (FIGS. 1, 3-4, 6-7) includes, but is not limited to, a clip, a suction cup, a base, a clamp, a bracket, and/or any support structure capable of securely connecting wind sock assembly 1 to a vehicle and/or vessel, such as a boat. FIG. 1 best shows attachment structure 11 positioned within an opening of window 13 of vehicle 12.

In an alternate embodiment, FIGS. 3-4 and 6-7 depict novel wind sock assembly 1 having support structure 26. Support structure 26 forms a housing having first end 28 located opposite second end 29. Support structure 26 is configured to retain sail switch 17 (FIGS. 1-4 and 6-7), paddle 18 of sail switch 17, and electrical components of inflation system. First end 28 of support structure housing 26 has U-shaped hoop guide 30 with track 32 bordering first opening 5 of support structure housing 26. Track 30 of U-shaped hoop guide 30 of support structure housing 26 is configured to retain hoop 7 and at least a portion of first end 3 of tapered sock 2. It is within the scope of the current invention for U-shaped hoop guide 30 to have at least a portion of magnetic material 52 and/or track 32 to be magnetic material 52 and/or hoop 7 to be made of a magnetic material. It is within the scope of this invention for at least a portion of first end 3 of tapered sock 2 to have a magnetic portion 50. Magnetic portion 50 of tapered sock is magnetically connected to magnetic material 52 of U-shaped hoop guide 30 and/or track 32. First end 3 of tapered sock 2 is retained within track 32 of U-shaped hoop guide 30.

Referring again to FIGS. 3-4 and 6-7, second end 29 of support structure housing 26 has lip 31 bordering second opening 34 of support structure housing 26. First opening 33 of support structure housing 26 is located opposite second opening 34 of support structure housing 26. Support structure housing 26 has sidewall 35. FIGS. 3-4 illustrate an embodiment in which sidewall 35 of support structure housing 26 has plurality of openings 36A-36C configured to facilitate airflow 53A-53G (FIG. 3).

FIG. 3 shows windsock assembly 1 having an inflation system with manual switch 19 oriented in “off” 24B configuration during windy conditions in which sail switch 19 is normally closed. Manual switch 19 is in electrical communication 23A with power source 22. Power source 22 is electrically connected 23B to motor 39. Sail switch 17 has paddle 18 extending from arm 54. Sail switch 17 has button 38. Sail switch 17 is electrically connected 23C to motor 39. Sail switch 17 is electrically connected 23D to manual switch 19. The inflation system may have extension member 27 having first opening 55 located opposite second opening 21. Extension member 27 has lip 41. Extension member 27 is retained within housing of support structure 26. Extension member 27 has flange 45 located on one end and lip 41 located on an opposite end. In the event a second extension member (not shown) is added to the inflation system, the second extension member would be nested within first extension member 27 and at least a portion of second extension member (not shown) would be retained within first extension member 27 with lip 41. Linear actuator 44 is connected to motor 39. Linear actuator 44 has an end of resilient member 46 connected to plate 47. Plate 47 is connected to at least a portion of flange 45 of extension member 27 or any portion of extension member 27. When manual switch 19 is positioned in an “off” 24B orientation, resilient member 46 is retracted and does not push extension member 27 out of opening 34 of support structure housing 26. Extension member 27 has sidewall 42 having at least one opening 43A-43C configured for airflow.

FIG. 4 shows windsock assembly 1 having an inflation system with manual switch 19 oriented in “on” 24A configuration during non-windy conditions in which sail switch 19 is normally opened (not shown). Manual switch 19 is in electrical communication 23A with power source 22. Power source 22 is electrically connected 23B to motor 39. Sail switch 17 has paddle 18 extending from arm 54. Sail switch 17 has button 38. Sail switch 17 is electrically connected 23C to motor 39. Sail switch 17 is electrically connected 23D to manual switch 19. The inflation system may have extension member 27 having first opening 55 located opposite second opening 21. Extension member 27 has lip 41. At least a portion of extension member 27 is retained within housing of support structure 26. Extension member 27 has flange 45 located on one end and lip 41 located on an opposite end. In the event a second extension member (not shown) is added to the inflation system, the second extension member would be nested within first extension member 27 and at least a portion of second extension member (not shown) would be retained within first extension member 27 with lip 41.

Referring again to FIG. 4, linear actuator 44 is connected to motor 39. Linear actuator 44 has an end of resilient member 46 connected to plate 47. Plate 47 is connected to at least a portion of flange 45 of extension member 27 or any portion of extension member 27. When manual switch 19 is positioned in an “on” 24A orientation, resilient member 46 is expanded and pushes at least a portion of extension member 27 out of opening 34 of support structure housing 26, whereby, tapered sock 2 is oriented in a horizontal and/or expanded orientation. Extension member 27 has sidewall 42 having at least one opening 43A-43C configured for airflow. In particular, flange 45 of extension member 27 is configured to connect to lip 31 bordering second opening 34 of housing of support structure 26 when linear actuator 44 orients shaft (not shown) and/or resilient member 46 in an extended orientation. Linear actuator 44 has a shaft (not shown) or resilient member 46 connected to plate 47.

FIG. 4 illustrates linear actuator 44 is electrically connected to motor 39. Motor 39 is configured to be activated to extend resilient member 46 of linear actuator 44 to push at least a portion of extension member 27 through second opening 34 of housing of support structure 26 when sail switch 17 is in a closed orientation when manual switch 19 is positioned “on” 24A in a closed orientation, whereby, button 38 of sail switch 17 is not depressed by arm 54 of sail switch 17 when no wind is detected by sail switch 17, thereby, transmitting an electronic signal from sail switch 17 to motor 39 to turn “on” motor 29 when no wind is detected by sail switch 17. It is within the scope of this invention for plate 27 of linear actuator 44 to be magnetically connected to at least a portion of extension member 27.

Referring now to FIGS. 6-7, windsock assembly 1 has inflation system having motor 39 being configured to be activated to rotate 40 (FIG. 6) shaft 20 connected to at least one fan blade 25 when sail switch 17 is in a normally closed orientation when manual switch 19 is positioned “on” 24A (FIG. 6) in a closed orientation, whereby, button 38 of sail switch 17 is not depressed (FIG. 6) by arm 54 of sail switch 17 when no wind is detected by sail switch 17, thereby, transmitting an electronic signal from sail switch 17 to motor 39 to turn “on” motor 39 when no wind is detected by sail switch 17. Manual switch 19 is in electrical communication 23A with power source 22. Power source 22 is electrically connected 23B to motor 39. Sail switch 17 has paddle 18 extending from arm 54. Sail switch 17 has button 38. Sail switch 17 is electrically connected 23C to motor 39. Sail switch 17 is electrically connected 23D to manual switch 19.

Referring now to FIG. 7, motor 39 is configured to be deactivated to not rotate shaft 20 connected to fan blade 25 when sail switch 17 is in an open orientation when manual switch 19 is positioned “on” 24A in a closed orientation, whereby, said force 37 of the wind retracts arm 54 of sail switch 17 into button 38 of sail switch 17, thereby, button 38 is depressed by arm 54 of sail switch 27 when wind is detected by sail switch 17, thereby, transmitting an electronic signal from sail switch 17 to motor 39 to turn “off” motor 39 when wind is detected by sail switch 17. When the force of the wind is capable of inflating tapered sock 2, for example, when a vehicle having a novel windsock assembly connected thereto, is moving down a road, there is no need foe a fan or linear actuator to assist in the inflation of tapered sock 2.

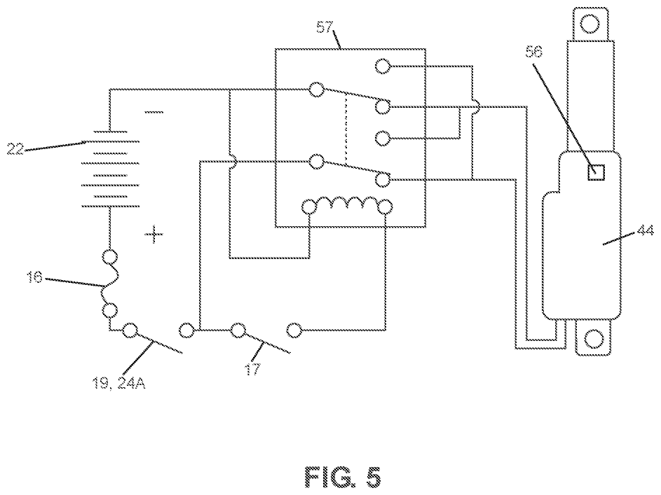

Referring now to FIG. 5, in a preferred embodiment, sail switch 17 receives wind and activates sail switch 17 and energizes double pole double throw relay 57. It is within the scope of this invention for double pole double throw relay 57 to power linear actuator 44 in an extended position. When sail switch 17 deenergizes double pole double throw relay 57, double pole double throw relay 57 powers linear actuator 44 with the reverse polarity which retracts linear actuator 44. In an alternate embodiment, sail switch 17 is in communication with circuitry that is capable of powering linear actuator 44 to extend linear actuator 44 when no wind is detected by sail switch 17. Circuitry sends power in a reverse polarity to linear actuator 44 to retract linear actuator 44. It is within the scope of this invention for linear actuator to have internal and/or external limit switch 56. Power source 22, such as 12 volt DC supply is in communication with fuse 16. Fuse 16 is in communication with manual switch 19.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. A self-expanding windsock assembly, comprising:
a tapered sock having an outer wall surface, said tapered sock having a first end having a first opening located opposite a second end having a second opening, said first opening of said first end of said tapered sock having an outer perimeter edge greater in size than an outer perimeter edge of said second opening of said second end of said tapered sock, said first end of said tapered sock having a pocket;
a hoop, said hoop is retained within said pocket of said first end of said tapered sock;
a rod having a first end located opposite a second end, said first end of said rod is connected to said hoop, said second end of said rod is connected to an attachment structure, said attachment structure is configured to connect to a vehicle; and,
a support structure, comprising:
a housing having a first end located opposite a second end, said first end of said housing having a U-shaped hoop guide bordering a first opening of said housing, said U-shaped hoop guide having a track configured to retain said hoop, said second end of said housing having a lip bordering a second opening of said housing, said housing having a sidewall.

2. The self-expanding windsock assembly of claim 1, further comprising:
said outer wall surface of said tapered sock having surface indicia located thereon,

3. The self-expanding windsock assembly of claim 1, further comprising:
said sidewall of said housing of said support structure having at least one opening configured for airflow.

4. The self-expanding windsock assembly of claim 1, further comprising:
said first end of said rod is connected to a bearing housing, said hoop is connected to said bearing housing of said first end of said rod, said bearing housing is configured to swivel said hoop.

5. The self-expanding windsock assembly of claim 1, further comprising:
an inflation system, comprising:
a manual switch, said manual switch is in electrical communication with a power source, said power source is electrically connected to a motor;
a sail switch, said sail switch having a paddle extending from an arm, said sail switch having a button, said sail switch is electrically connected to said motor, said sail switch is electrically connected to said manual switch;
said motor is configured to be activated to rotate a shaft connected to a fan blade when said sail switch is in a closed orientation when said manual switch is positioned “on” in a closed orientation, whereby, said button of said sail switch is not depressed by said arm of said sail switch when no wind is detected by said sail switch, thereby, transmitting an electronic signal from said sail switch to said motor to turn “on” said motor when no wind is detected by said sail switch; and,
said motor is configured to be deactivated to not rotate said shaft connected to said fan blade when said sail switch is in an open orientation when said manual switch is positioned “on” in a closed orientation, whereby, said the force of the wind retracts said arm of said sail switch into said button of said sail switch, thereby, said button is depressed by said arm of said sail switch when wind is detected by said sail switch, thereby, transmitting an electronic signal from said sail switch to said motor to turn “off” said motor when wind is detected by said sail switch.

6. The self-expanding windsock assembly of claim 1, further comprising:
an inflation system, comprising:
an extension member, said extension member is retained within said housing of said support structure, said extension member having a flange, said flange of said extension member is configured to connect to said lip of said second opening of said housing of said support structure;
a manual switch, said manual switch is in electrical communication with a power source, said power source is electrically connected to a motor;
a sail switch, said sail switch having a paddle extending from an arm, said sail switch having a button, said sail switch is electrically connected to said motor, said sail switch is electrically connected to said manual switch;
a linear actuator, said linear actuator having a shaft connected to a plate, said linear actuator is electrically connected to said motor; and,
said motor is configured to be activated to extend said shaft of said linear actuator to push at least a portion of said extension member through said second opening of said housing of said support structure when said sail switch is in a closed orientation when said manual switch is positioned “on” in a closed orientation, whereby, said button of said sail switch is not depressed by said arm of said sail switch when no wind is detected by said sail switch, thereby, transmitting an electronic signal from said sail switch to said motor to turn “on” said motor when no wind is detected by said sail switch.

7. The self-expanding windsock assembly of claim 6, further comprising:
said plate of said linear actuator is magnetically connected to at least a portion of said extension member.

8. A self-expanding windsock assembly, comprising:
a tapered sock, said tapered sock having a first end having a first opening located opposite a second end having a second opening, said first opening of said first end of said tapered sock having an outer perimeter edge greater in size than an outer perimeter edge of said second opening of said second end of said tapered sock,
said tapered sock having surface indicia located on an outer wall surface of said tapered sock;
a hoop, said hoop is retained within said pocket of said first end of said tapered sock; and,
a rod having a first end located opposite a second end, said first end of said rod is connected to said hoop, said second end of said rod is connected to an attachment structure, said attachment structure is configured to connect to a vehicle.

9. The self-expanding windsock assembly of claim 8, further comprising:
at least a portion of said first end of said tapered sock being a magnetic material.

10. The self-expanding windsock assembly of claim 9, further comprising:
a support structure, comprising:
a housing, said housing is located within said tapered sock and extends at least a portion of the length of said tapered sock, said housing having a first end located opposite a second end, said first end of said housing having a U-shaped hoop guide having a track, said U-shaped hoop guide borders a first opening of said housing, at least a portion of said track of said U-shaped hoop guide being a magnetic material, said at least a portion of said first end of said tapered sock is retained within said track of said U-shaped hoop guide, whereby, said magnetic material of said at least a portion of said tapered sock is magnetically connected to said magnetic material of said track of said U-shaped hoop guide.

11. The self-expanding windsock assembly of claim 10, further comprising:
said second end of said housing having a lip bordering a second opening of said housing, said housing having a sidewall.

12. The self-expanding windsock assembly of claim 11, further comprising:
an inflation system, comprising:
an extension member, said extension member is retained within said housing of said support structure, said extension member having a flange, said flange of said extension member is configured to connect to said lip of said second opening of said housing of said support structure;
a manual switch, said manual switch is in electrical communication with a power source, said power source is electrically connected to a motor;
a sail switch, said sail switch having a paddle extending from an arm, said sail switch having a button, said sail switch is electrically connected to said motor, said sail switch is electrically connected to said manual switch;
a linear actuator, said linear actuator having a shaft connected to a plate, said linear actuator is electrically connected to said motor; and,
said motor is configured to be activated to extend said shaft of said linear actuator to push at least a portion of said extension member through said second opening of said housing of said support structure when said sail switch is in a closed orientation when said manual switch is positioned “on” in a closed orientation, whereby, said button of said sail switch is not depressed by said arm of said sail switch when no wind is detected by said sail switch, thereby, transmitting an electronic signal from said sail switch to said motor to turn “on” said motor when no wind is detected by said sail switch.
